(19) United States
(12) Patent Application Publication
(10) Pub. No.: US 2006/0265581 A1
(43) Pub. Date: Nov. 23, 2006

(54) METHOD FOR SWITCHING BOOTING DEVICES OF A COMPUTER

(76) Inventors: Dai-Hua Sun, Shenzhen (CN); Shang-Qing Zhou, Shenzhen (CN); Zhi-Fang Wu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,455

(22) Filed: Mar. 28, 2006

(30) Foreign Application Priority Data
May 20, 2005 (CN) 200510034748.4

(51) Int. Cl. G06F 15/177

(52) U.S. Cl. 713/1

(57) ABSTRACT

The present invention provides a method for switching booting devices of a computer (10). The method includes the steps of: powering on the computer, and executing basic input/output system power on self test (BIOS POST) program; trying to boot the computer from a primary booting device (14); reading a boot program (151) of a secondary booting device (15) into a particular portion of a memory (12) of the computer; determining whether the boot program of the secondary booting device is valid for normal booting of the computer; executing the boot program of the secondary booting device, if the boot program of the secondary booting device is valid for normal booting of the computer; and booting the computer from the secondary booting device. A related computer is also provided.

### DESCRIPTION

1. Field of the Invention

The present invention is generally related to methods for booting a computer, and more particularly, is related to a method for changing booting devices of a computer.

2. Description of Related Art

A computer can be booted from different booting devices, such as a floppy drive, a hard disk, a compact disk and/or a flash memory according to various requirements of a user. Therefore, a computer needs to pass various tests for booting from different booting devices before being shipped out of factory to customers. It could be a problem to change booting devices of a plurality of computers in mass production, because conventionally changing booting devices requires resetting Complementary Metal-Oxide-Semiconductor Transistor (CMOS) of the computers manually by test engineers. It is time-consuming in mass production, and is a major obstacle to achieve full production automation.

There are however, some advances in computer testing. A typical one is to prepare different CMOSs corresponding to various booting devices by programming. When there is a need in changing booting devices, the CMOSs are loaded for execution. However, computers of different hardware configuration generally have different CMOSs. So, if computers of different hardware configuration are being tested, the CMOSs need to be changed frequently.

What is needed, therefore, is a solution that can change booting devices of a computer conveniently without frequently changing the CMOSs manually.

### SUMMARY OF THE INVENTION

One embodiment of a computer is provided. The computer includes a memory, a primary booting device, and a secondary booting device. The primary booting device and the secondary booting device each includes a boot program for booting the computer. The primary booting device further includes a boot program reading module, a determining module, and a jumping module. Specifically, the boot program reading module is used for reading the boot program of the secondary booting device into a predetermined portion of the memory of the computer. The determining module is used for determining whether the boot program of the secondary booting device is valid for normal computer booting. The jumping module is used for executing the boot program of the secondary booting device, if the boot program of the secondary booting device is valid for normal computer booting.

One embodiment of a method for switching booting devices of a computer is also provided. The method includes the steps of: powering on the computer and executing basic input/output system power on self test (BIOS POST) program; defaulting to boot the computer from a primary booting device; reading a boot program of a secondary booting device into a predetermined portion of a memory of the computer; determining whether the boot program of the secondary booting device is valid for normal computer booting; executing the boot program of the secondary booting device, if the boot program of the secondary booting device is valid for normal computer booting; and booting the computer from the secondary booting device.

Other systems, methods, features, and advantages of the present invention will be or become apparent to one with skill in the art upon examination of the following drawings and detailed description.

### BRIEF DESCRIPTION OF DRAWINGS

FIG. 1 is a schematic diagram illustrating basic hardware configuration of a computer, in accordance with one preferred embodiment;

FIG. 2 is a schematic diagram illustrating function modules of a primary booting device of FIG. 1; and

FIG. 3 is a flowchart of a preferred method for switching booting devices of a computer.

### DETAILED DESCRIPTION

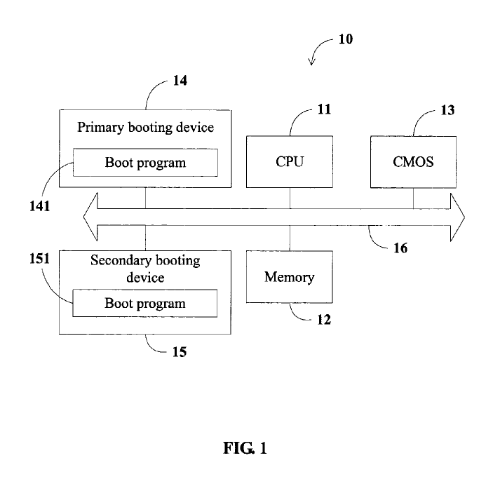

FIG. 1 is a schematic diagram illustrating basic hardware configuration of a computer, in accordance with one preferred embodiment. The computer 10 primarily includes a central processing unit (CPU) 11, a memory 12, a complementary metal-oxide-semiconductor transistor (CMOS) 13, a primary booting device 14, a secondary booting device 15, and a bus 16 connecting all the above introduced units. The computer 10 may also include other units or hardware, such as a network adapter, an audio card, a graphic accelerating card, a keyboard, a mouse, and so on. However, in order to describe the preferred embodiment concisely, these units are not shown in the drawings.

The CPU 11 is used for processing data and codes in the memory 12 that stores the data and codes temporarily. The CMOS 13 is a transistor for storing a basic input/output system (BIOS) that includes information on booting sequences and devices of computer 10, and also for storing a BIOS power on self test (POST) program. The primary booting device 14 includes a boot program 141 which can be executed by the CPU 11 to boot computer 10. The secondary booting device 15 also includes a boot program 151 that can also be executed by the CPU 11 to boot computer 10. The bus 16 is used for exchanging data between the units connected thereto.

The primary booting device 14 and the secondary booting device 15 can be any one from the group consisting of a floppy drive, a hard disk, a compact disk, and a flash memory. The primary booting device 14 and the secondary booting device 15 may be different booting devices, or even the same booting devices. According to the information on the booting sequence recorded in the CMOS 13, the primary booting device 14 is chosen preferentially to boot computer 10, while the secondary booting device 15 is a standby booting device for computer 10.

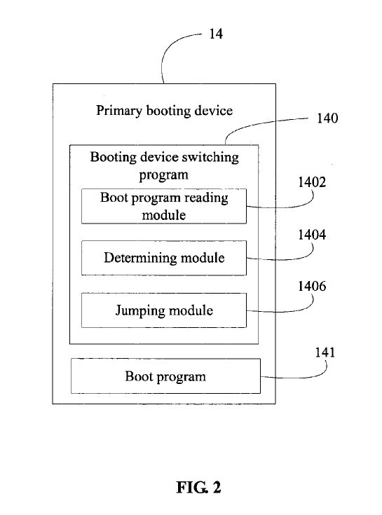

FIG. 2 is a schematic diagram illustrating function modules of the primary booting device 14. Besides the boot program 141 for booting computer 10, the primary booting device 14 further includes a booting device switching program 140 for changing the booting device from the primary booting device 14 to the secondary booting device 15.

The booting device switching program 140 has its codes embedded in the primary booting device 14, and includes a boot program reading module 1402, a determining module 1404, and a jumping module 1406. Specifically, the boot program reading module 1402 is used for reading the boot program 151 of the secondary booting device 15 into a predetermined portion of the memory 12 of the computer 10. The predetermined portion of the memory 12 may be, for example, addresses 0000:7C000.

The determining module 1404 is used for determining whether the boot program 151 is valid for normal booting of the computer 10. In this preferred embodiment, the determining module 1404 reads a value of the last two bytes of the zero sector of the boot program 151 loaded in memory 12. If the value is AA55, the boot program 151 is valid for normal booting of the computer 10, otherwise, if the value is not AA55, the boot program 151 is invalid.

The jumping module 1406 is used for executing the boot program 151 of the secondary booting device 15, if the boot program 151 of the secondary booting device 15 is valid for normal booting of the computer 10. When powered on, the computer 10 chooses the primary booting device 14 to boot. The CPU 11 reads codes in the primary booting device 14 and stores the codes into the memory 12, then executes the codes of the booting device switching program 140 first instead of the boot program 141. After executing the booting device switching program 140, if the boot program 151 of the secondary booting device 15 is valid for normal booting the of the computer 10, the CPU 11 jumps to execute the boot program 151 of the secondary booting device 15 to boot the computer 10.

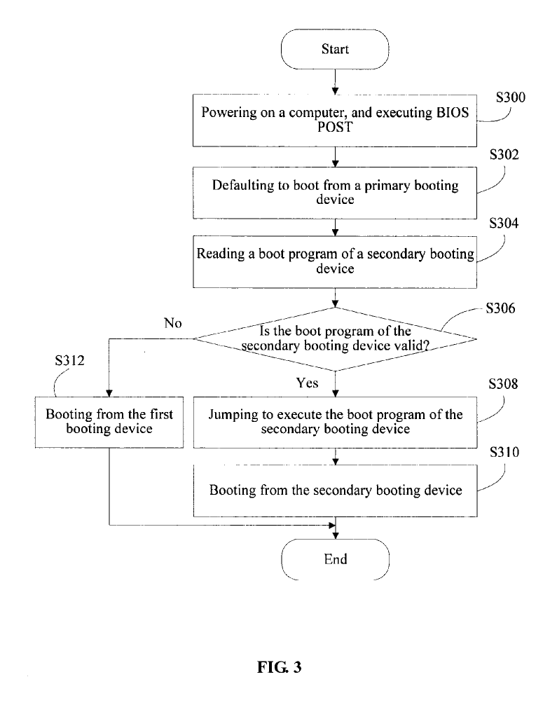

FIG. 3 is a flowchart of a preferred method for switching booting devices of the computer 10. In step S300, the computer 10 is powered on and the CPU 11 executes the POST program. In step S302, the computer 10 tries to boot from the primary booting device 14. Specifically, the CPU 11 reads codes in the primary booting device 14 stores the codes into the memory 12, then executes the codes of the booting device switching program 140 first instead of the boot program 141. In step S304, the boot program reading module 1402 reads the boot program 151 of the secondary booting device 15 into a predetermined portion of the memory 12 of the computer 10. The predetermined portion of the memory 12 may be addresses 0000:7C000. In step S306, the determining module 1404 determines whether the boot program 151 is valid for normal booting of the computer 10. Specifically, the determining module 1404 reads a value of the last two bytes of the zero sector of the boot program 151 loaded in the memory 12. If the value is AA55, the boot program 151 is valid for normal booting of the computer 10, otherwise, if the value is not AA55, the boot program 151 is invalid.

If the boot program 151 is valid for normal booting of the computer 10, in step S308, the jumping module 1406 executes the boot program 151 of the secondary booting device 15. In step S310, the computer 10 boots from the secondary booting device 15 by executing the boot program 151.

On the other hand, if the boot program 151 is invalid for normal booting of the computer 10, in step S312, the computer 10 normally boots from the primary booting device 14 by executing the boot program 141.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A computer comprising:
a memory;
a primary booting device comprising a boot program for booting the computer from where the
primary booting device is located; and
a secondary booting device comprising a boot program for booting the computer from where the secondary booting device is located;
the primary booting device further comprising:
a boot program reading module for reading the boot program of the secondary booting device and storing the boot program into a predetermined portion of the memory of the computer;
a determining module for determining whether the boot program of the secondary booting device is valid for normal booting of the computer; and
a jumping module for executing the boot program of the secondary booting device, if the boot program of the secondary booting device is valid for normal booting of the computer.

2. The computer according to claim 1, wherein the predetermined portion of the memory are addresses 0000:7C000.

3. The computer according to claim 1, wherein the primary booting device is selected from the group consisting of a floppy drive, a hard disk, a compact disk, and a flash memory.

4. The computer according to claim 1, wherein the secondary booting device is selected from the group consisting of a floppy drive, a hard disk, a compact disk, and a flash memory.

5. A method for switching booting devices of a computer, the method comprising the steps of:
powering on the computer, and executing a basic input/output system power on self test (BIOS POST) program;
defaulting to boot the computer from a primary booting device;
reading a boot program of a secondary booting device and storing the boot program in a predetermined portion of a memory of the computer;
determining whether the boot program of the secondary booting device is valid for normal booting of the computer;
jumping to execute the boot program of the secondary booting device, if the boot program of the secondary booting device is valid; and
booting the computer from the secondary booting device.

6. The method according to claim 5, wherein the predetermined portion of the memory are addresses 0000:7C000.

7. The method according to claim 5, wherein the determining step comprises the steps of:
reading a value of the last two bytes of the zero sector of the boot program;
determining the boot program of the secondary booting device is valid for normal booting of the computer, if the value is AA55; and
determining the boot program of the secondary booting device is invalid for normal booting of the computer, if the value is not AA55.

8. The method according to claim 5, wherein the primary booting device is selected from the group consisting of a floppy drive, a hard disk, a compact disk, and a flash memory.

9. The method according to claim 5, wherein the secondary booting device is selected from the group consisting of a floppy drive, a hard disk, a compact disk, and a flash memory.

10. A primary booting device for switching a computer to boot from itself to a secondary booting device, the primary booting device comprising:
a boot program reading module for reading a boot program of the secondary booting device and storing the boot program into a predetermined portion of a memory of the computer;
a determining module for determining whether the boot program of the secondary booting device is valid for normal booting of the computer; and
a jumping module for executing the boot program of the secondary booting device, if the boot program of the secondary booting device is valid.

11. The primary booting device according to claim 10, further comprising a boot program for normal booting of the computer.

12. The primary booting device according to claim 10, wherein the predetermined portion of the memory are addresses 0000:7C000.

13. The primary booting device according to claim 10, wherein the determining module determines the boot program of the secondary booting device is valid for normal booting of the computer if a value of the last two bytes of the zero sector of the boot program is AA55.

14. The primary booting device according to claim 10, wherein the primary booting device is selected from the group consisting of a floppy drive, a hard disk, a compact disk, and a flash memory.

15. The primary booting device according to claim 10, wherein the secondary booting device is selected from the group consisting of a floppy drive, a hard disk, a compact disk, and a flash memory.
